(19) United States
(12) Patent Application Publication
(10) Pub. No.: US 2022/0172253 A1
(43) Pub. Date: Jun. 2, 2022

(54) SYSTEM, APPARATUS, METHOD, AND USER INTERFACE CONFIGURED FOR TRANSMISSION OF DATA VIA A WIRELESS AD-HOC NETWORK

(71) Applicant: Groupon, Inc., Chicago, IL (US)

(72) Inventor: Eric HYCHE, Chicago, IL (US)

(21) Appl. No.: 17/449,880

(22) Filed: Oct. 4, 2021

Related U.S. Application Data
(63) Continuation of application No. 14/103,093, filed on Dec. 11, 2013, now abandoned.

(51) Int. Cl. G06Q 30/02

(52) U.S. Cl. CPC G06Q 30/0267

(57) ABSTRACT

A system and related devices and methods facilitating sharing of a promotion between a first device and a second device are disclosed herein. An exemplary system may comprise a first device and a second device. An exemplary first device may comprise processing circuitry configured to display one or more promotions, receive a selection of at least one promotion, a selection of at least one second device, the second device within a predetermined proximity, and an indication to transmit the at least one promotion to the at least one second device, and transmit wirelessly the at least one promotion to the at least one second device. A second device may comprise processing circuitry configured to receive a notification indicating that the first device is sharing a promotion, display an indication indicating reception of the notification, receive a selection of an acceptance of the promotion, and display the promotion.

### FIELD

Embodiments of the invention relate, generally, to providing a system, apparatus, method, and user interface that enables a user to share a promotion displayed on their mobile device with a user operating a second mobile device.

### BACKGROUND

Conventional sharing methods generally require two users to both have an account with the same social network out of the plurality of social networks available and for both users to be logged in, thereby limiting any time savings over just searching for the promotion via a known search method. In this regard, areas for improving current systems have been identified. Through applied effort, ingenuity, and innovation, solutions to improve such systems have been realized and are described in connection with embodiments of the present invention.

### BRIEF SUMMARY

In general, embodiments of the present invention provided herein include systems, methods and computer readable media for providing a system that enables sharing of a promotion by a first user having a first account operating a first device with one or more second users, each having a second account and operating a second device.

In one embodiment, a device is provided. The device may comprise processing circuitry configured to display one or more promotions, at least one promotion being an indication of an agreement for a particular provider to provide a service or good to a consumer, receive a selection of at least one promotion, a selection of at least one second device, the at least one second device within a predetermined proximity, and an indication to transmit the at least one promotion to the at least one second device, and transmit wirelessly the at least one promotion to the at least one second device.

In some embodiments, the device further comprising processing circuitry configured to display a list of second devices configured to connect to the device, wherein the selection of the at least one second device is from among the list of second devices configured to connect to the device. In some embodiments, the device may further comprise processing circuitry configured to receive a selection of one or more second devices identified as able to receive wireless communication from the device, transmit a request to connect to each of one or more second devices identified as able to receive wireless communication from the device, receive confirmation from at least a portion of the one or more second devices identified as able to receive wireless communication from the device, and generate the list of second devices configured to connect to the device.

In some embodiments, the device may further comprise processing circuitry configured to identify one or more second devices able to receive wireless communication from the device, and generate a list of second devices able to receive wireless communication from the device. In some embodiments, the device and the at least one second device are configured as part of a wireless ad-hoc network. In some embodiments, the device may further comprise processing circuitry configured to identify the at least one second device via at least one of near field communication, ad-hoc wireless network or Bluetooth. In some embodiments, the device may further comprise processing circuitry configured to receive an indication of whether the shared promotion was accepted or declined by the at least one second device, and display the indication of whether the shared promotion was accepted or declined by the at least one second device.

In another embodiment, a device may be provided, the device comprising processing circuitry configured to receive a notification indicating that the first device is sharing a promotion, display an indication indicating reception of the notification, receive a selection of an acceptance of the promotion, display the promotion, and transmit an indication to the second device of acceptance of the promotion. In some embodiments, the device may further comprise processing circuitry configured to reveal itself in response to a request to identify devices able to receive wireless communication from the device, receive an invitation to connect to a second device, display an indication indicating reception of the invitation to connect to the second device, receive a selection of an acceptance of the invitation, and connect to the second device. In some embodiments, the device may further comprise processing circuitry configured to display the indication indicating reception of the notification and an option to purchase the promotion concurrently.

In another embodiment, a method may be provided, the method comprising displaying one or more promotions, at least one promotion being an indication of an agreement for a particular provider to provide a service or good to a consumer, receiving a selection of at least one promotion, a selection of at least one second device, the at least one second device within a predetermined proximity, and an indication to transmit the at least one promotion to the at least one second device, and transmitting wirelessly the at least one promotion to the at least one second device.

In some embodiments, the method may further comprise displaying a list of second devices configured to connect to the device, wherein the selection of the at least one second device is from among the list of second devices configured to connect to the device. In some embodiments, the method may further comprise receiving a selection of one or more second devices identified as able to receive wireless communication from the device, transmitting a request to connect to each of one or more second devices identified as able to receive wireless communication from the device, receiving confirmation from at least a portion of the one or more second devices identified as able to receive wireless communication from the device, and generating the list of second devices configured to connect to the device.

In some embodiments, the method may further comprise identifying one or more second devices able to receive wireless communication from the device, and generating a list of second devices able to receive wireless communication from the device. In some embodiments, the device and the at least one second device are configured as part of a wireless ad-hoc network. In some embodiments, the method may further comprise identifying the at least one second device via at least one of near field communication, ad-hoc wireless network or Bluetooth. In some embodiments, the method may further comprise receiving an indication of whether the shared promotion was accepted or declined by the at least one second device, and displaying the indication of whether the shared promotion was accepted or declined by the at least one second device.

In another embodiment, a method may be provided, the method comprising receiving a notification indicating that the first device is sharing a promotion, displaying an indication indicating reception of the notification, receiving a selection of an acceptance of the promotion, displaying the promotion, and transmitting an indication to the second device of acceptance of the promotion. In some embodiments, the method may further comprise revealing itself in response to a request to identify devices able to receive wireless communication from the device, receiving an invitation to connect to a second device, displaying an indication indicating reception of the invitation to connect to the second device, receiving a selection of an acceptance of the invitation, and connecting to the second device. In some embodiments, the method may further comprise displaying the indication indicating reception of the notification and an option to purchase the promotion concurrently.

In another embodiment, a computer program product may be provided, the computer program product comprising at least one computer-readable storage medium having computer-executable program code instructions stored therein, the computer-executable program code instructions comprising program code instructions for displaying one or more promotions, at least one promotion being an indication of an agreement for a particular provider to provide a service or good to a consumer, receiving a selection of at least one promotion, a selection of at least one second device, the at least one second device within a predetermined proximity, and an indication to transmit the at least one promotion to the at least one second device, and transmitting wirelessly the at least one promotion to the at least one second device.

In some embodiments, the computer-executable program code instructions further comprise program code instructions for displaying a list of second devices configured to connect to the device, wherein the selection of the at least one second device is from among the list of second devices configured to connect to the device. In some embodiments, the computer-executable program code instructions further comprise program code instructions for receiving a selection of one or more second devices identified as able to receive wireless communication from the device, transmitting a request to connect to each of one or more second devices identified as able to receive wireless communication from the device, receiving confirmation from at least a portion of the one or more second devices identified as able to receive wireless communication from the device, and generating the list of second devices configured to connect to the device.

In some embodiments, the computer-executable program code instructions further comprise program code instructions for identifying one or more second devices able to receive wireless communication from the device, and generating a list of second devices able to receive wireless communication from the device. In some embodiments, the device and the at least one second device are configured as part of a wireless ad-hoc network. In some embodiments, the computer-executable program code instructions further comprise program code instructions for identifying the at least one second device via at least one of near field communication, ad-hoc wireless network or Bluetooth. In some embodiments, the computer-executable program code instructions further comprise program code instructions for receiving an indication of whether the shared promotion was accepted or declined by the at least one second device, and displaying the indication of whether the shared promotion was accepted or declined by the at least one second device.

In another embodiment, a computer program product may be provided, the computer program product comprising at least one computer-readable storage medium having computer-executable program code instructions stored therein, the computer-executable program code instructions comprising program code instructions for receiving a notification indicating that the first device is sharing a promotion, displaying an indication indicating reception of the notification, receiving a selection of an acceptance of the promotion, displaying the promotion, and transmitting an indication to the second device of acceptance of the promotion. In some embodiments, the computer-executable program code instructions further comprise program code instructions for revealing itself in response to a request to identify devices able to receive wireless communication from the device, receiving an invitation to connect to a second device, displaying an indication indicating reception of the invitation to connect to the second device, receiving a selection of an acceptance of the invitation, and connecting to the second device. In some embodiments, the computer-executable program code instructions further comprise program code instructions for displaying the indication indicating reception of the notification and an option to purchase the promotion concurrently.

### BRIEF DESCRIPTION OF THE DRAWINGS

Having thus described some embodiments in general terms, reference will now be made to the accompanying drawings, which are not necessarily drawn to scale, and wherein:

FIG. 1 shows an example schematic block diagram of circuitry, configured in accordance with some embodiments;

FIG. 2 shows a flow chart of an example method, performed in accordance with some embodiments;

FIGS. 3 shows a flow chart of an example method, performed in accordance with some embodiments;

FIGS. 4A-4D show example graphical user interface displays that may be presented by various components of systems, in accordance with some embodiments;

FIGS. 5A and 5B show flow charts of an example methods, performed in accordance with some embodiments;

FIGS. 6A-6K show example graphical user interface displays that may be presented by various components of systems, in accordance with some embodiments;

FIGS. 7 shows a flow chart of an example method of operation of the second device, in accordance with some embodiments;

FIGS. 8A-8C show example graphical user interface displays that may be presented by various components of systems, in accordance with some embodiments; and

FIG. 9 shows an example schematic block diagram of circuitry, configured in accordance with some embodiments.

### DETAILED DESCRIPTION

Embodiments will be described more fully hereinafter with reference to the accompanying drawings, in which some, but not all embodiments contemplated herein are shown. Indeed, various embodiments may be implemented in many different forms and should not be construed as limited to the embodiments set forth herein; rather, these embodiments are provided so that this disclosure will satisfy applicable legal requirements. Like numbers refer to like elements throughout.

### Definitions

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

A “promotion and marketing service” may provide promotion and/or marketing services on behalf of one or more providers (e.g., one or more merchants, retailers, etc.) that are offering one or more instruments that are redeemable for goods, services, experiences and/or the like. The promotion and marketing service is further configured to illustrate or otherwise inform one or more consumers of the availability of one or more instruments in the form of one or more impressions. In some examples, the promotion and marketing service may also take the form of a redemption authority, a payment processor, a rewards provider, an entity in a financial network, a promoter, an agent and/or the like. As such, the service is, in some example embodiments, configured to present one or more promotions via one or more impressions, accept payments for promotions from consumers, issue instruments upon acceptance of an offer, participate in redemption, generate rewards, provide a point of sale device or service, issue payments to providers and/or or otherwise participate in the exchange of goods, services or experiences for currency, value and/or the like.

A “promotion” may be a deal purchased by a consumer from a promotional system, and may be considered an agreement for a particular provider to provide a service or good (e.g., a discounted service or good) to the consumer. A promotion may include, but is not limited to, any type of offered, presented or otherwise indicated reward, discount, coupon, credit, deal, incentive, discount, media or the like that is indicative of a promotional value or the like that upon purchase or acceptance results in the issuance of an instrument that may be used toward at least a portion of the purchase of particular goods, services and/or experiences defined by the promotion. An example promotion may be a deal offer whereby a running shoes company or intermediary (e.g., promotion provider) offers $50 of value toward the purchase of running shoes in exchange for $25. In some examples, the promotion defines an accepted value (e.g., a cost to purchase the promotion), a promotional value (e.g., the value of the resultant instrument beyond the accepted value), a residual value (e.g., the value upon return or upon expiry of one or more redemption parameters), one or more redemptions parameters and/or the like. For example, and using the running shoes company promotion as an example, the accepted value is $25 and the promotional value is $50. In this example, the residual value may be equal to the accepted value.

An “instrument” associated with a promotion may include, but is not limited to, any type of gift card, tender, electronic certificate, medium of exchange, voucher, or the like that embodies the terms of the promotion from which the instrument resulted and may be used toward at least a portion of the purchase, acquisition, procurement, consumption or the like of goods, services and/or experiences. In some examples, the instrument may take the form of tender that has a given value that is exchangeable for goods, services and/or experiences and/or a reduction in a purchase price of a particular good, service or experience. In some examples, the instrument may have multiple values, such as an accepted value, a promotional value and/or a residual value. For example, using the aforementioned running shoes company as the example provider, an electronic indication in a mobile application that shows $50 of value to spend at the running shoes company. In some examples, the accepted value of the instrument is defined by the value exchanged for the instrument. In some examples, the promotional value is defined by the promotion from which the instrument resulted and is the value of the instrument beyond the accepted value. In some examples, the residual value is the value after redemption, the value after the expiry or other violation of a redemption parameter, the return or exchange value of the instrument and/or the like.

A “provider” may be considered a merchant, retailer, or other provider of goods or services that offers a promotion, as agreed upon with the promotion and marketing service affiliated with the promotional system. A provider may include, but is not limited to, a merchant, business owner, consigner, shopkeeper, tradesperson, vender, operator, entrepreneur, agent, dealer, retailer, organization or the like that is in the business of a providing a good, service or experience to a consumer, facilitating the provision of a good, service or experience to a consumer and/or otherwise operating in the stream of commerce. For example, a provider may the form of a running shoes company that sells attire that is generally used by a person who runs or participates in athletic activities.

An “impression” may be considered a communication advertising an offer to purchase a promotion from a promotional system. An impression may include a communication, a display, or other perceived indication, such as a flyer, print media, e-mail, text message, application alert, mobile applications, other type of electronic interface or distribution channel and/or the like, of one or more promotions. For example, and using the aforementioned running company as the example provider, an e-mail communication sent to consumers that indicates the availability of a $25 for $50 toward running shoes promotion.

Impressions are therefore provided to “consumers,” including, but not limited to, a client, customer, purchaser, shopper, user of the promotional system or the like who may be in the position to or does exchange value for one or more instruments under the terms defined by the one or promotions. For example, and using the aforementioned running shoes company as the example provider, an individual who is interested in purchasing running shoes.

More specifically, embodiments provided herein may include a system that may be implemented to provide a user interface that enables a user to share an impression or a promotion displayed on their mobile device with a user operating a second mobile device.

Some embodiments described herein may include one or more methods for performing the functionality described herein and/or non-transitory computer readable media storing instructions for performing the one or more methods that are executable by a processor. Other embodiments may include machines, such as an apparatus and/or system, configured to implement the methods and/or other functionality discussed herein. For example, the machine may include one or more processors and/or other machine components configured to implement the functionality discussed herein based on instructions and/or other data stored in memory, circuitry, and/or non-transitory computer readable media.

These characteristics as well as additional features, functions, and details of various corresponding and additional embodiments are described below.

### Overview

The methods, apparatus and computer program products described herein are operable for the providing a system that enables sharing of a promotion by a first user having a first account operating a first device with one or more second or additional users, each having a second account and operating a second device that are within a predetermined proximity, such as within near field communication (NFC) range. As such, a person or, in some embodiments, a provider may share promotions with a friend, customer, or the like without the second user having to search for the promotion.

In some embodiments, the first user may select a promotion, identify nearby users using near field communication, Bluetooth, Wi-Fi, or the like, select one or more identified nearby users and share the promotion. Each selected user may then be notified of the shared promotion by, for example, a selected device configured to receive the shared promotion information, display a notification of the shared promotion information, enable the purchase of the shared promotion and, in some embodiments, receive a selection of whether to display, save, or reject the shared promotion. In some embodiments, the second device may be configured to notify the first device of the acceptance or rejection of the promotion. The first device may then be configured to display information regarding the acceptance or rejection of the promotion. In some embodiments, the first account may link to promotion system, identify and/or select other users, and share promotion.

An advantage that may be realized by some example embodiments discussed herein allows for sharing without searching. For example, a person may share a promotion with a friend without the friend having to search for the promotion. In another example, a provider may share a promotion with a customer upon the customer approaching and/or entering a particular area. Another advantage that may be realized herein allows for a system where a person can send promotions to another person without each of the one or more persons having to login to a social network, website or the like. Another advantage that may be realized by some example embodiments discussed herein is that the second device can be configured to save shared promotions for viewing or use at a later time.

Other advantages that may be realized by some embodiments discussed herein include allowing a merchant or merchant account to share impressions, promotions or provide promotional offerings (e.g., impressions, vouchers, sales, discounts, rewards, or the like) to a consumer. While in yet further examples, lists of promotions, preferred promotions, wishlist promotions or the like may be shared to known or unknown users in a given proximity.

Some embodiments herein may be configured such that information related shared promotions and/or accepted promotions may be input into a system or apparatus configured to determine relevance or demand. For example, information related shared promotions and/or accepted promotions may be used in relevance determinations. In each of U.S. patent application Ser. No. 13/411,502, filed Mar. 2, 2012, titled “RELEVANCE SYSTEM FOR CONSUMER DEALS”, U.S. patent application Ser. No. 13/829,581 entitled “Promotion Offering System” and filed on Mar. 14, 2013, U.S. patent application Ser. No. 12/776,028, now U.S. Pat. No. 8,355,948, titled “SYSTEM AND METHODS FOR DISCOUNT RETAILING” filed on May 7, 2010, each of which is hereby incorporated by reference, algorithms are provided for matching consumers to relevant promotions.

In some embodiments, information related shared promotions and/or accepted promotions may be used in such demand for particular promotions may be determined. In each of U.S. patent application Ser. No. 13/826,333, filed Mar. 14, 2013, titled “METHOD, APPARATUS, AND COMPUTER PROGRAM PRODUCT FOR DEMAND FORECASTING”, U.S. patent application Ser. No. 13/803,445, filed Mar. 14, 2013, titled “METHOD, APPARATUS, AND COMPUTER PROGRAM PRODUCT FOR SALES PIPELINE AUTOMATION”, and U.S. Provisional Patent Application No. 61/730,046, titled “METHOD AND APPARATUS FOR MATCHING SUBSCRIBER DEMAND WITH MERCHANT/INVENTORY SUPPLY” filed on Nov. 26, 2012”, each of which is hereby incorporated by reference, algorithms are provided for calculating demand.

### Example System Architecture

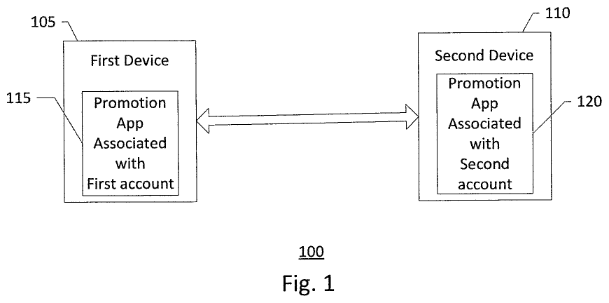

FIG. 1 is a block diagram showing an exemplary system 100 for a system that enables sharing of a promotion by a first user having a first account operating a first device with one or more second users, each having a second account and operating a second device. The system 100 may be configured to include a first device 105 and a second device 110. The first device 105, as described above may be a mobile phone, personal computer, tablet, mobile device or the like, and may be configured to store and run a promotion application (“app”) 115 with which a first account may be associated. The first account may be accessed with a, for example, username and password or a device ID and may be configured to store saved and/or purchased promotions. The promotion app may be configured to display one or more impressions, promotions, or the like. The first device 105 may be further configured to identify nearby devices by for example, near field communication methods, Bluetooth, Wi-Fi, or the like. The first device 105 may be configured to share promotions with identified devices or via a promotional and marketing service.

The system 100 may be further configured to include at least one second device 110. The second device may also be configured to run the promotion app 120. The second device 110 may be further configured to be discovered by, for example, a device configured to identify nearby devices.

In some configurations, the first device 105 may be a provider device. In such instances, the first device 105 may identify devices that, for example, enter a particular area (e.g., a restaurant, a store, a mall or the like).

In some configurations, the first device 105 may be configured to communicate with a promotion and marketing system, a central system or like, and access data. Data may include permission information indicating a particular user's consent to share offer information even when not nearby.

### High Level Exemplary Process

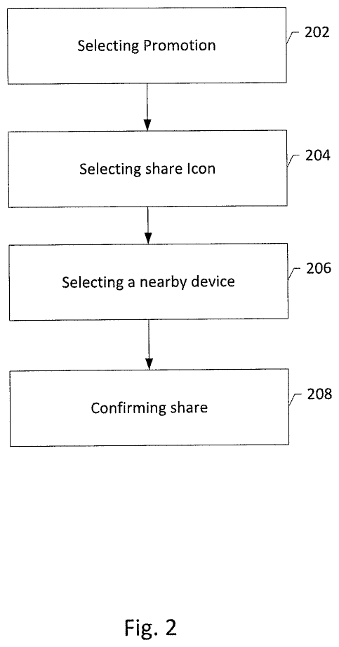

FIG. 2 shows an example process where a first user shares an impression, promotion or the like with a second user. The first user may be operating a mobile device, such as a cellular phone, tablet, or the like. The mobile device may be running a mobile application or “app”, such as promotion app 115, configured for displaying one or more promotions. The second user may also possess or be operating a mobile device, the mobile device also configured for running the mobile application. As shown, at 202, the first user may select a promotion. For example, while walking into a restaurant, the first user may remember that she purchased a promotion for the particular restaurant. Wishing to share the promotion with a friend (e.g., the second user), the first user may execute the mobile application configured for displaying promotions and navigate to the particular promotion she wishes to share. At 204, the first user may then select by, for example, clicking on a share icon. The share icon may be displayed in a portion of the screen of the mobile and in some embodiments, overlaid on the displayed promotion. In some embodiments, the share icon may be accessed from a menu. Once the first user selects the share icon, the first user may then select one or more nearby devices, as shown at 206. For example, once the share icon is selected, the mobile device may then display nearby devices identified by, for example, any one of or any combination of near field communication, Bluetooth, WiFi, or the like. In some examples, the mobile device may display nearby devices as determined by inclusion in or use of the same an ad-hoc service, such as a self-configuring infrastructureless network of mobile devices connected wirelessly. For example, each mobile device in a wireless ad-hoc network is free to move independently in any direction, and will therefore change its links to other devices frequently. The mobile device may display devices currently identified in its wireless ad-hoc network.

Referring back to FIG. 2, the first user, recognizing her friend's mobile device on the list of identified devices, may then select her friend's device. Once the second device is selected, the first user may then confirm by selecting a share confirmation icon, as shown at 208. For example, once the first user selects her friend's device from a list, she may select a share confirmation icon (e.g., a share button located on the same display screen as the list of selectable devices) in order to share the promotion. The second user may then be notified of the shared promotion and choose to for example, view the shared promotion, purchase the shared promotion, save the shared promotion, or decline the shared promotion.

### Set-Up Process Overview

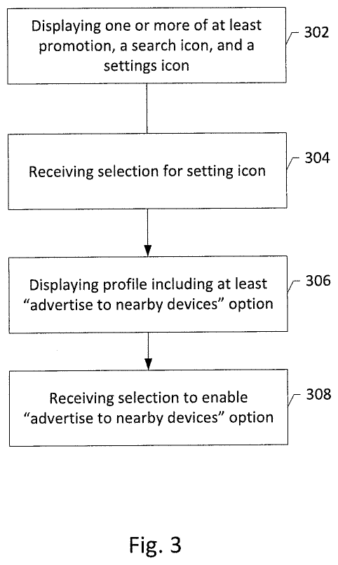

In some embodiments, in order to allow sharing of a promotion by a first user having a first account operating a first device with one or more second users, each having a second account and operating a second device, the first device may be enabled. In other words, a user may first enable sharing, for example, via the first account. Accordingly, before a first device or a first account configured for sharing a promotion or the like may be provided, an enablement process may, first, be performed. In some examples, the first user, second user, provider or another user may initiate or perform an enablement process for allowing the sharing or receiving of shared promotions. FIG. 3 shows a flow chart of an example method for enabling sharing, in accordance with some embodiments.

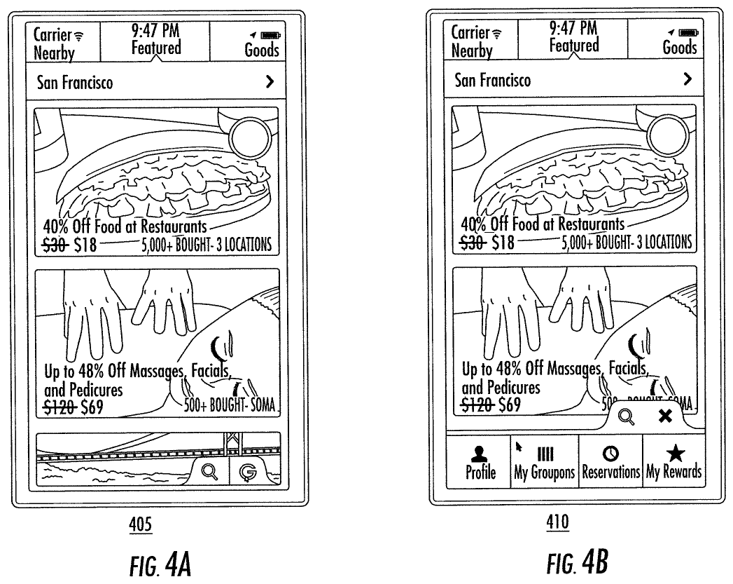

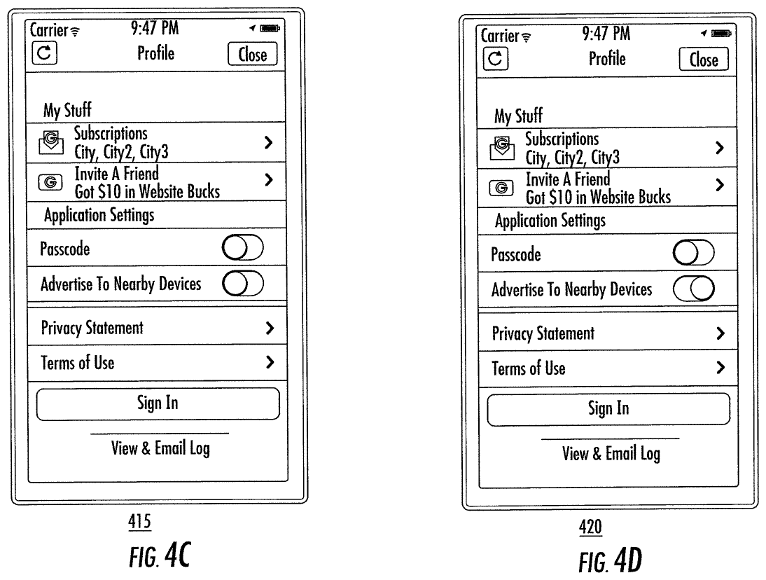

Method 300 will be described with reference to example displays 405-420 shown in FIGS. 4A-4D, respectively. FIGS. 4A-4D show example displays 405, 410, 415, and 420 that may be presented by one or more display screens of one or more devices, such as those used by a first user, second user, provider or the like, which as described above, are referred to herein as a “first device”, “second device”, and “provider device” respectively. While the example displays 405, 410, 415, and 420 are configured to be shown on a mobile telephone, “smart phone” or other device having similar dimensions, similar interfaces may be utilized with other types of devices discussed herein and modified accordingly (e.g., for screen size, input device compatibly, ease of use, etc.).

In some embodiments, any physical device may be configured to perform the functionalities described herein. For example, a device may be configured to share a promotion and also receive a shared promotion, among other things described herein. In some embodiments, any physical device may be configured to perform the techniques described herein via one or more applications or web applications.

In some embodiments, the techniques described herein may be implemented via one or more applications that execute locally and causes a user's device to be configured to function as a specialized machine. Additionally or alternatively, cloud-based, multi-tenant, thin-client, and/or other types of networked service techniques may be used. For example, one or more functionalities described herein as being performed by a first device or a second device may execute on a remote device, such as a server and/or other networked machine. User input information may be generated by and sent from the, for example, first device to the remote device, or from the remote device to the first device, while visual and/or audio information is sent from the remote device to the first device, or from the first device to the remote device, respectively.

Turning back to FIG. 3, as shown in block 302 of FIG. 3, an apparatus, such as first device 105, may be configured for displaying and/or providing a one or more of at least promotion, a search icon, a settings icon, or the like and, as shown in step 304, receiving an indication of a selection for the settings icon. For example, display 405 of FIG. 4A shows a display screen that may be displayed by a first device. Display 405, like some or all of the other displays discussed herein, may be accessed by virtually any method, such as an application executing locally. Display 405 may be configured to allow for, for example, a user (e.g., an employee or consumer) to initiate a process for enabling sharing. Display 410 may be configured to receive an input indication of a selection of a settings icon.

After receiving an input indication of a selection of a settings icon, as shown in block 306 of FIG. 3, an apparatus, such as first device 105, may be configured for displaying profile including at least “advertise to nearby devices” option. As such, as shown in FIG. 4C, a display 415 may be configured to provide, for example, a profile screen including at least a place to input an “advertise to nearby devices” option. As shown in block 308 of FIG. 3, an apparatus, such as first device 105, may be configured for receiving a selection to enable “advertise to nearby devices” option. As such, as shown in FIG. 4D, a display 420 may be configured to receive a selection of an “advertise to nearby devices” option, and, in some embodiments, display the option turned on. In some embodiments, enabling the “advertise to nearby devices” option or the like allows the apparatus to receive shared promotions. However, in some embodiments, in order to share a promotion, enablement of an advertisement function may not be necessary. In other embodiments, the apparatus may be configured to always advertise to nearby devices. In still other embodiments, the apparatus may, by default, advertise to nearby device, and allow a selection to be made to disable the advertising function.

In some embodiments, enablement of an advertising function (e.g., the “advertise to nearby devices” option) may be requested at start-up of the apparatus or of the application. In other embodiments, an alternative or additional option may enable an “instant share” function. By enabling “instant share”, the apparatus may display the share icon on each promotion. In other embodiments, selection of the instant share option may remove the step of selecting “instant share” from the list of other sharing alternatives, thereby saving a step (e.g., select share and then go to selecting other devices to share with).

### Sharing

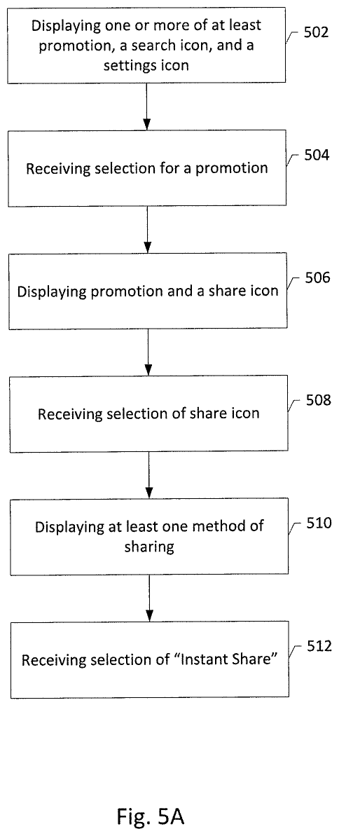

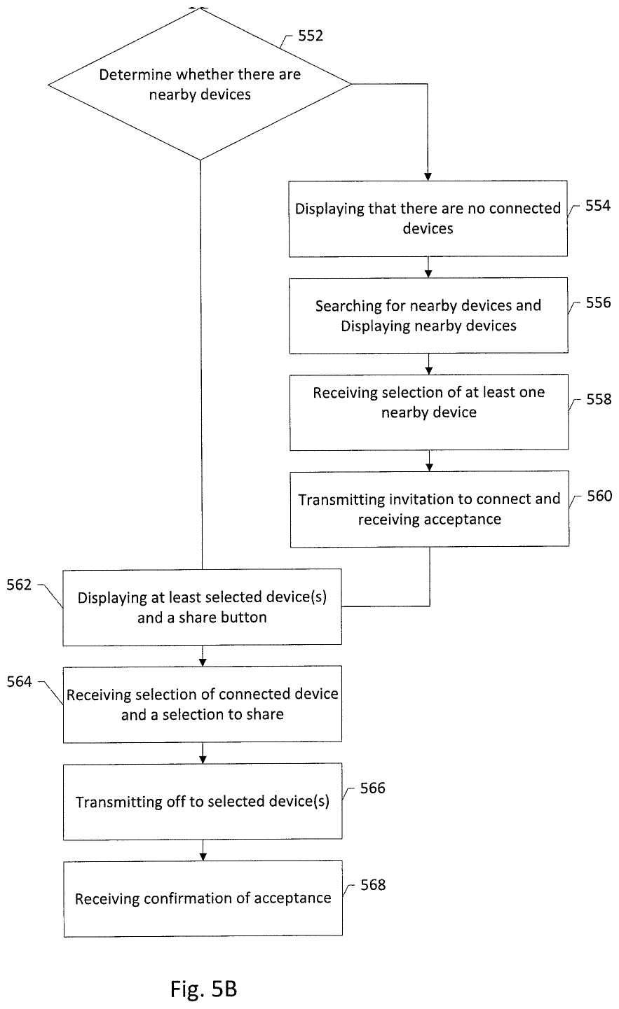

In some embodiments, a first device enabled for sharing of a promotion may also be configured for traditional methods of sharing, such as via one of a plurality of social networks. As such, instant share may be selected from among other (e.g., traditional) methods for sharing (e.g., email, text message, etc.). Accordingly, in some embodiments, before a first device or a first account configured for sharing a promotion or the like may perform a sharing process, instant sharing may be selected. FIG. 5A shows a flow chart of an example method for selecting an instant share process, in accordance with some embodiments.

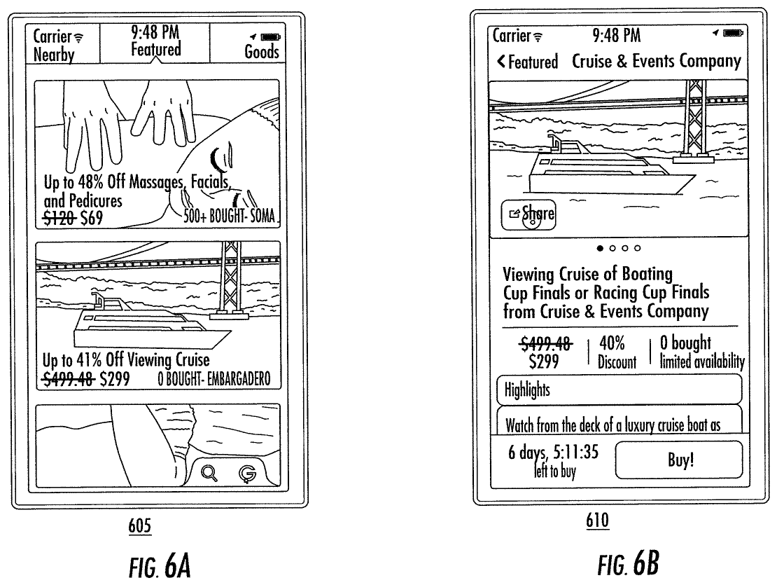

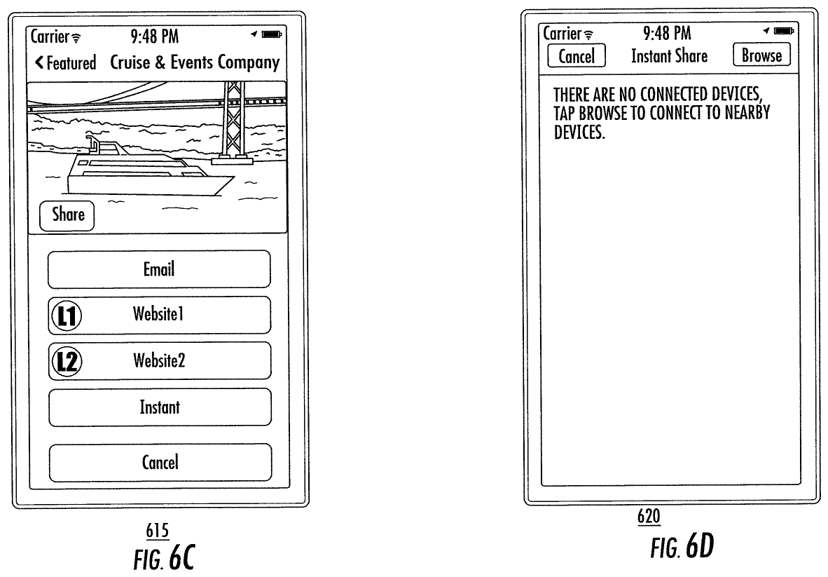

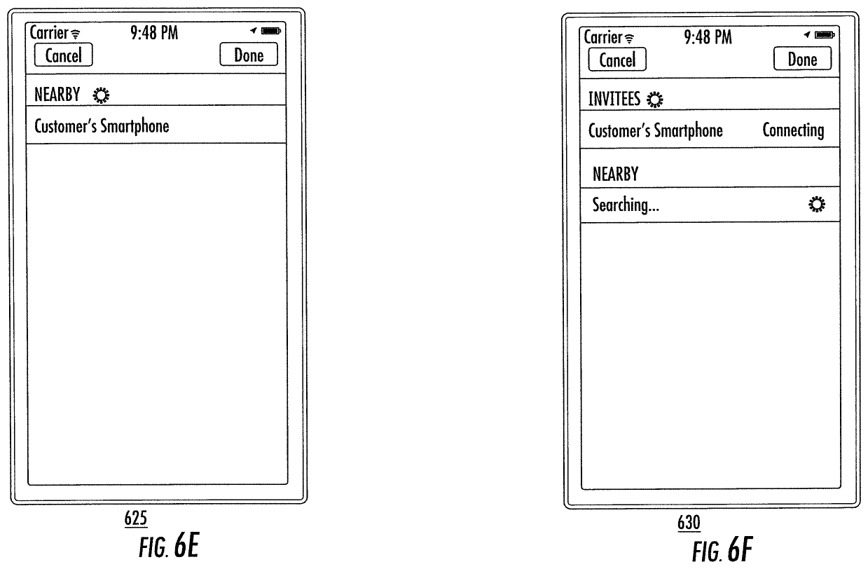

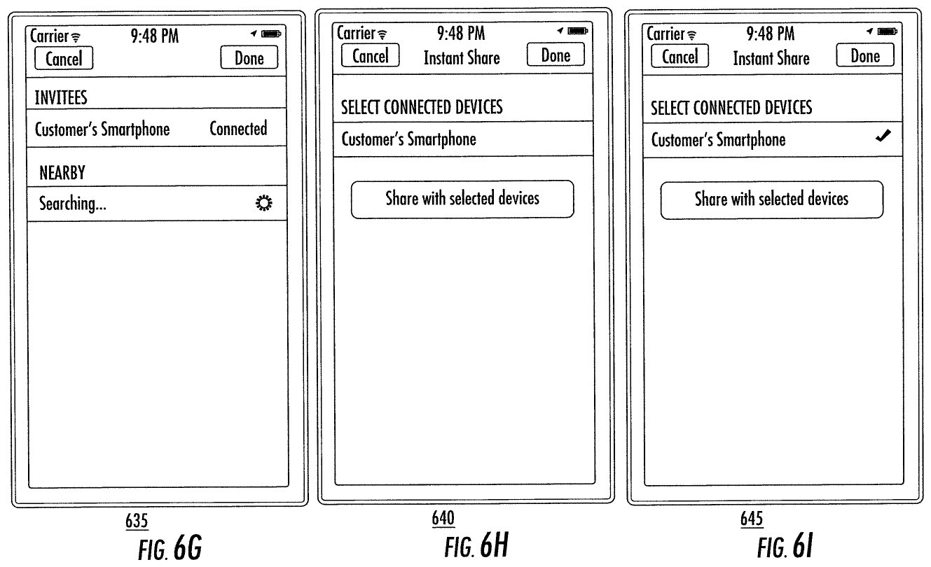

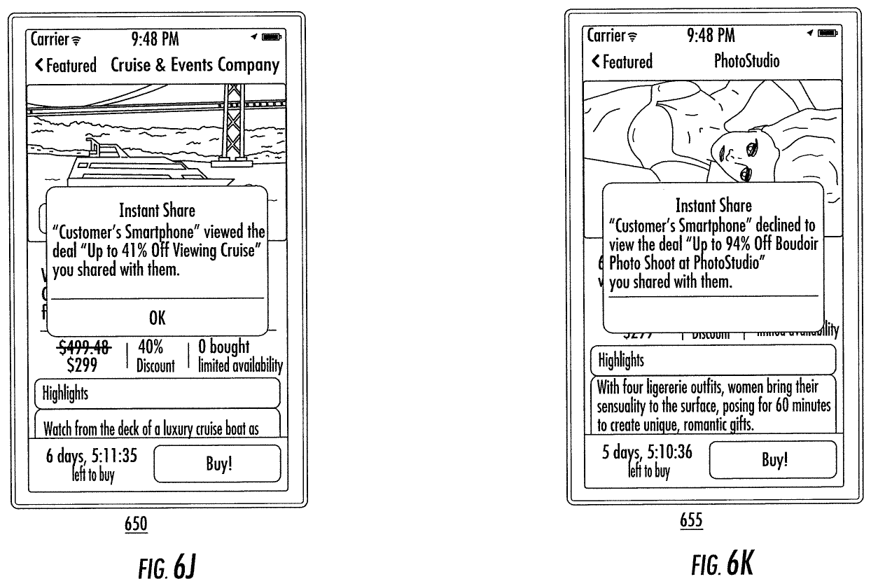

Method 500 will be described with reference to example displays 605-615 shown in FIGS. 6A-6C, respectively. FIGS. 6A-6C show example displays 605, 610, and 615 that may be presented by one or more display screens of one or more devices, such as those used by a first user, second user, provider or the like, which as described above, are referred to herein as a “first device”, “second device”, and “provider device” respectively. Again, while the example displays 605, 610, and 615 are configured to be shown on a mobile telephone, “smart phone” or other device having similar dimensions, similar interfaces may be utilized with other types of devices discussed herein and modified accordingly (e.g., for screen size, input device compatibly, ease of use, etc.). And again, in some embodiments, any physical device may be configured to perform the functionalities described herein. For example, a device may be configured to share a promotion and also receive a shared promotion, among other things described herein.

Turning back to FIG. 5A, as shown in block 502 of FIG. 5A, an apparatus, such as first device 105, may be configured for displaying and/or providing a one or more of at least promotion, a search icon, a settings icon, or the like and, as shown in step 504, receiving an indication of a selection for a promotion. For example, display 605 of FIG. 6a shows a display screen that may be displayed by a first device. Display 605 may be configured to display at least one promotion, and allow for, for example, a first user to select a promotion.

As shown in block 506 of FIG. 5A, an apparatus, such as first device 105, may be configured for displaying promotion and a share icon and, as shown in step 508, receiving an indication of a selection of the share icon. For example, Display 610 may be configured to display the selected promotion and receive selection of the share icon.

As shown in block 510 of FIG. 5A, an apparatus, such as first device 105, may be configured for displaying at least one method of sharing and, as shown in step 512, receiving an indication of a selection of “instant share.” Display 615 may be configured to display a plurality of methods of sharing, including email, Facebook®, Twitter®, and instant share. In some examples, the first device 105 may be configured to receive selection of instant.

In some embodiments, the apparatus may be configured to proceed to a selection of device with which to share the promotion, as will be shown in FIG. 5B. In some embodiments, an apparatus, such as first device 105, may be configured for proceeding to a selection of device with which to share the promotion, as will be shown in FIG. 5B after receiving selection of the share icon in step 508.

### Sharing

In some embodiments, once sharing is enabled and a sharing process is initiated by selecting a promotion to share, a first device may be enabled to identify one or more second devices with which to share the selected promotion. In some instances, device with which to share are searched for and identified, and in some embodiments, one or more other devices are identified and may be selected for sharing. Accordingly, in some embodiments, before a first device or a first account configured for sharing a promotion or the like may perform a sharing process, one or more second devices may be selected. FIG. 5B shows a flow chart of an example method for selecting one or more second devices, in accordance with some embodiments.

The method of FIG. 5B will be described with reference to example displays 620-645 shown in FIGS. 6D-6K, respectively. FIGS. 6D-6K show example displays 620-645 that may be presented by one or more display screens of one or more devices, such as those used by a first user, second user, provider or the like, which as described above, are referred to herein as a “first device”, “second device”, and “provider device” respectively. Again, while the example displays 620-645 are configured to be shown on a mobile telephone, “smart phone” or other device having similar dimensions, similar interfaces may be utilized with other types of devices discussed herein and modified accordingly (e.g., for screen size, input device compatibly, ease of use, etc.). And again, in some embodiments, any physical device may be configured to perform the functionalities described herein. For example, a device may be configured to share a promotion and also receive a shared promotion, among other things described herein.

Turning back to FIG. 5B, as shown in block 552 of FIG. 5B, an apparatus, such as first device 105, may be configured for determining whether there are connected devices. In an instance in which there are no connected devices, as shown in step 554 of FIG. 5B, an apparatus, such as first device 105, may be configured for displaying that there are no connected devices and, in some embodiments, either as a result of user input or as a default option, as shown in block 556, searching for nearby devices. For example, display 620 of FIG. 6D shows a display screen that may be displayed by a first device. Display 620 may be configured to display an indication that there are no connected devices. Display 620, in an embodiment where searching is not by default, may further provide instructions indicating how to initiate searching for nearby devices. After initiating a searching for nearby devices, as shown in block 556, an apparatus, such as first device 105, may be configured for displaying nearby devices. For example, display 625 of FIG. 6e shows a display screen that may be displayed by a first device. Display 625 may be configured to display results of the search process.

As shown in block 558 of FIG. 5B, an apparatus, such as first device 105, may be configured for receiving selection of at least one nearby device. As shown in block 560 of FIG. 5b, an apparatus, such as first device 105, may then be configured for transmitting an invitation to connect and, upon acceptance by one or more second devices, receiving confirmation of acceptance. For example, display 630 of FIG. 6F shows a display screen that may be displayed by a first device. Display 630 may be configured to display an indication that there the first device is connecting. In some embodiments, the search for nearby devices may continue while awaiting acceptance from a second device of an invitation to connect.

In some embodiments, after receiving an acceptance to connect from one or more second device, as shown in block 560, or in an instance in which the determination in block 552 indicates that the first device is connected to or able to connect to at least one second device, an apparatus, such as first device 105, may be configured for, as shown in block 562, displaying of one or more connected devices and, in some embodiments, a selection to share. For example, display 635 of FIG. 6G shows a display screen that may be displayed by a first device. Display 635 may be configured to display one or more connected devices. As can be seen, in some embodiments, a search for nearby device may continue, and as such, the display screen 635 may be configured to display an indication as such.

As shown in block 564 of FIG. 5B, an apparatus, such as first device 105, may then be configured for receiving selection of one or more connected devices and a selection to share. For example, displays 640 of FIGS. 6h and 645 of FIG. 6I show a display screens that may be displayed by a first device. Display 640 may be configured to display one or more connected devices and an icon indicating a share selection. In some embodiments, the icon may not be selected until at least one connected device is selected for sharing. Display 645 may be configured to show a selected connected device and a “share with selected devices” icon enabled to be selected.

As shown in block 566 of FIG. 5B, an apparatus, such as first device 105, may then be configured for transmitting information identifying the selection promotion. As shown in block 568 of FIG. 5B, an apparatus, such as first device 105, may then be configured for receiving a confirmation of acceptance or a decline of the shared promotion. For example, displays 650 of FIG. 6J and display 655 of FIG. 6K show a display screens that may be displayed by a first device. Display 650 may be configured to display an indication that the shared promotion was viewed by the second device. Display 655 may be configured to display an indication that the shared promotion was declined by the second device.

### Second Device

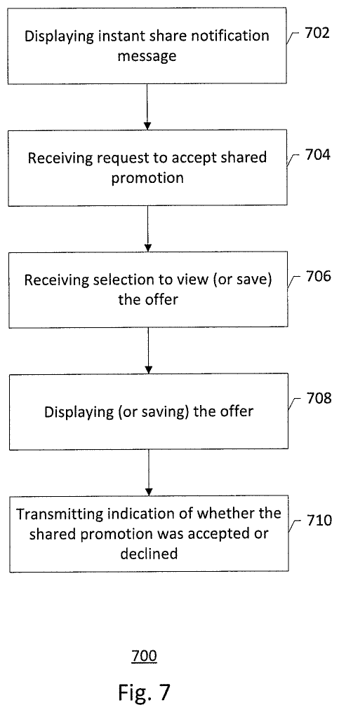

In some embodiments, once sharing is enabled and a sharing process is initiated by a first device having identified one or more second devices with which to share a promotion, the user of the second device may accept an invitation to connect. Once connected, the user of the second device may be alerted when the user of the first device identifies a promotion to share. In some instances, the second device may be configured to display the invitation to connect and a notification that a promotion has been shared. The second device may also be configured to provide the user with options to connect or not to connect, or, in other examples, to view, save, or accept a shared promotion. Accordingly, in some embodiments, before a first device may share a promotion, the second device may display the invitation to connect and wait for a response from the user, and in some embodiments, before a shared promotion may be displayed, the second device may display a notification of the shared promotion and wait for a response regarding what action to take. FIG. 7 shows a flow chart of an example method of operation of the second device, in accordance with some embodiments.

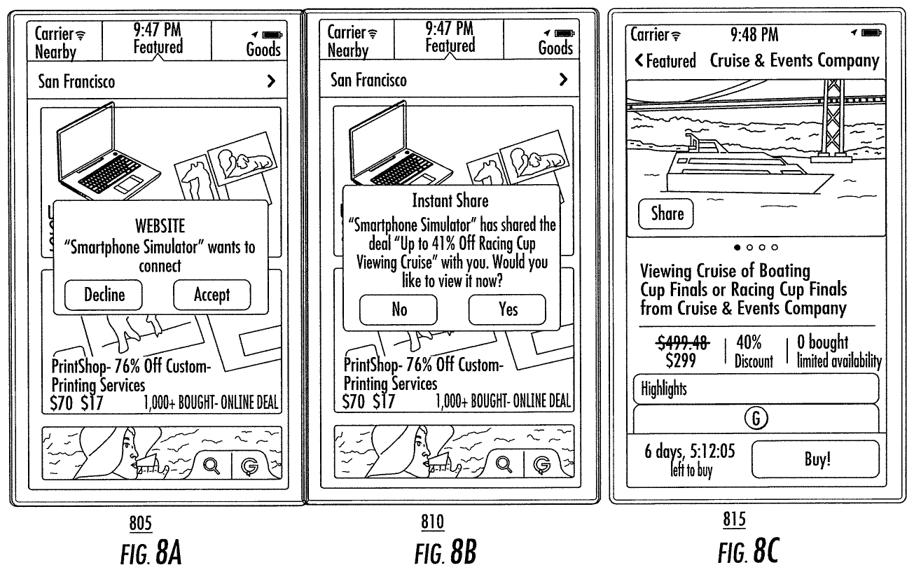

The method of FIG. 7 will be described with reference to example displays 805-815 shown in FIGS. 8A-8C, respectively. FIGS. 8A-8C show example displays 805, 810, and 815 that may be presented by one or more display screens of one or more devices, such as those used by a first user, second user, provider or the like, which as described above, are referred to herein as a “first device”, “second device”, and “provider device” respectively. Again, while the example displays 805, 810, and 815 are configured to be shown on a mobile telephone, “smart phone” or other device having similar dimensions, similar interfaces may be utilized with other types of devices discussed herein and modified accordingly (e.g., for screen size, input device compatibly, ease of use, etc.). And again, in some embodiments, any physical device may be configured to perform the functionalities described herein. For example, a device may be configured to share a promotion and also receive a shared promotion, among other things described herein.

Turning back to FIG. 7, as shown in block 702 of FIG. 7, an apparatus, such as first device 105, may be configured for receiving and/or displaying a notification indicating that a first user and/or first device is attempting to connect to the apparatus. For example, when walking into a store or the like, one friend may want to share a promotion with a second friend operating the apparatus. As such, the apparatus may be configured to be recognized when the first device attempts to identify nearby devices. In some embodiments, the second device may be configured to allow an incoming request and/or receiving a request to connect. The apparatus may then be configured to display an indication of receiving of such a request.

In some embodiments, when the application isn't running on the second device, reception of a connection request or shared promotion may cause a notification or alert to be displayed on the second device (e.g., a push notification). In some embodiments, where the first device is a merchant, the first device may transmit connection request or shared promotions to all or some subset of all second devices that enter a particular area (e.g., the merchant's place of business).

For example, display 805 of FIG. 8A shows a display screen that may be displayed by a first device or second device with which a promotion may be shared. Display 805 may be configured to display an indication that a first device (e.g., “iPhone simulator”) wants to connect. Note that “iphone simulator” is an example embodiment used in creation of the screenshots. The indication from the first device may be any word or set of words indicative of the first device or user of the first device. For example, if the first device is in “contacts” of the second device, the stored name may be displayed. In some embodiments, the user of the first device may choose a name. In other embodiments, the displayed name may be the name on the account of the app running on the first device. The apparatus may further be configured to display at least two options (e.g., decline and accept) and receive a response from the user wherein receiving an accept response allows the second device to connect to the first device and a decline response allows the second device to not connect to the first device.

Turning back to FIG. 7, as shown in block 704 of FIG. 7, an apparatus, such as first device 105, may be configured for receiving an indication that a first device is requesting to share a promotion or promotion information and/or displaying such an indication of the request. For example, if a first device performs, for example, a process shown in FIGS. 5A and/or 5B and shares a promotion with the apparatus, the apparatus may be configured to receive a request to accept the shared promotion and display the request. Furthermore, as shown in block 706 of FIG. 7, an apparatus, such as first device 105, may be configured for receiving a selection indicating whether to view a shared promotion.

For example, display 810 of FIG. 8B shows a display screen that may be displayed by a first device or second device with which a promotion may be shared. Display 810 may be configured to display an indication that a first device (e.g., “iPhone simulator”) wants to share a promotion. For example, the apparatus may further be configured to display at least two options (e.g., yes and no) and receive a response from the user wherein receiving a yes response allows the second device to receive the shared promotion and a no response allows the second device to not receive the shared promotion.

Turning back to FIG. 7, as shown in block 708 of FIG. 7, an apparatus, such as first device 105, may be configured for displaying the shared promotion. For example, display 815 of FIG. 8C shows a display screen that may be displayed by a first device or second device with which a promotion may be shared. Display 815 may be configured to display a shared promotion. As shown in block 710 of FIG. 7, an apparatus, such as first device 105, may be further configured for transmitting an indication of whether the shared promotion was accepted or declined.

### Exemplary System Architecture

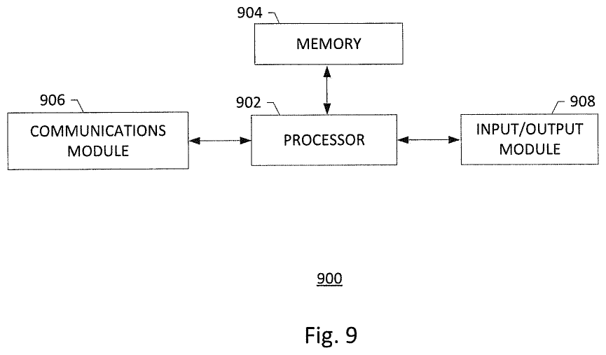

FIG. 9 shows a schematic block diagram of circuitry 900, some or all of which may be included in, for example, the first device or the second device. In accordance with some example embodiments, circuitry 900 may include various means, such as one or more processors 902, memories 904, communications modules 906, and/or input/output modules 908.

As referred to herein, “module” includes hardware, software and/or firmware configured to perform one or more particular functions. In this regard, the means of circuitry 900 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 904) that is executable by a suitably configured processing device (e.g., processor 902), or some combination thereof.

Processor 902 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 9 as a single processor, in some embodiments, processor 902 comprises a plurality of processors. The plurality of processors may be embodied on a single computing device or may be distributed across a plurality of computing devices collectively configured to function as circuitry 900. The plurality of processors may be in operative communication with each other and may be collectively configured to perform one or more functionalities of circuitry 900 as described herein. In an example embodiment, processor 902 is configured to execute instructions stored in memory 904 or otherwise accessible to processor 902. These instructions, when executed by processor 902, may cause circuitry 900 to perform one or more of the functionalities of circuitry 900 as described herein.

Whether configured by hardware, firmware/software methods, or by a combination thereof, processor 902 may comprise an entity capable of performing operations according to embodiments of the present invention while configured accordingly. Thus, for example, when processor 902 is embodied as an ASIC, FPGA or the like, processor 902 may comprise specifically configured hardware for conducting one or more operations described herein. As another example, when processor 902 is embodied as an executor of instructions, such as may be stored in memory 904, the instructions may specifically configure processor 902 to perform one or more algorithms and operations described herein.

Memory 904 may comprise, for example, volatile memory, non-volatile memory, or some combination thereof. Although illustrated in FIG. 9 as a single memory, memory 904 may comprise a plurality of memory components. The plurality of memory components may be embodied on a single computing device or distributed across a plurality of computing devices. In various embodiments, memory 904 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 904 may be configured to store information, data, applications, instructions, or the like for enabling circuitry 900 to carry out various functions in accordance with example embodiments discussed herein. For example, in at least some embodiments, memory 904 is configured to buffer input data for processing by processor 902. Additionally or alternatively, in at least some embodiments, memory 904 may be configured to store program instructions for execution by processor 902. Memory 904 may store information in the form of static and/or dynamic information. This stored information may be stored and/or used by circuitry 900 during the course of performing its functionalities.

Communications module 906 may be embodied as any device or means embodied in circuitry, hardware, a computer program product comprising computer readable program instructions stored on a computer readable medium (e.g., memory 904) and executed by a processing device (e.g., processor 902), or a combination thereof that is configured to receive and/or transmit data from/to another device, such as, for example, a second circuitry 900 and/or the like. In some embodiments, communications module 906 (like other components discussed herein) can be at least partially embodied as or otherwise controlled by processor 902. In this regard, communications module 906 may be in communication with processor 902, such as via a bus. Communications module 906 may include, for example, an antenna, a transmitter, a receiver, a transceiver, network interface card and/or supporting hardware and/or firmware/software for enabling communications with another computing device. Communications module 906 may be configured to receive and/or transmit any data that may be stored by memory 904 using any protocol that may be used for communications between computing devices. Communications module 906 may additionally or alternatively be in communication with the memory 904, input/output module 908 and/or any other component of circuitry 900, such as via a bus.

Input/output module 908 may be in communication with processor 902 to receive an indication of a user input and/or to provide an audible, visual, mechanical, or other output to a user. Some example visual outputs that may be provided to a user by circuitry 900 are discussed in connection with the displays described above. As such, input/output module 908 may include support, for example, for a keyboard, a mouse, a joystick, a display, an image capturing device, a touch screen display, a microphone, a speaker, a RFID reader, barcode reader, biometric scanner, and/or other input/output mechanisms. In embodiments wherein circuitry 900 is embodied as a server or database, aspects of input/output module 908 may be reduced as compared to embodiments where circuitry 900 is implemented as an end-user machine (e.g., consumer device and/or merchant device) or other type of device designed for complex user interactions. In some embodiments (like other components discussed herein), input/output module 908 may even be eliminated from circuitry 900. Alternatively, such as in embodiments wherein circuitry 900 is embodied as a server or database, at least some aspects of input/output module 908 may be embodied on an apparatus used by a user that is in communication with circuitry 900, such as for example, client device 105 or 110. Input/output module 908 may be in communication with memory 904, communications module 906, and/or any other component(s), such as via a bus. Although more than one input/output module and/or other component can be included in circuitry 900, only one is shown in FIG. 9 to avoid overcomplicating the drawing (like the other components discussed herein).

A non-transitory computer readable storage media can be configured to store firmware, one or more application programs, and/or other software, which include instructions and other computer-readable program code portions that can be executed to control processors of the components of system 900 to implement various operations, including the examples shown above. As such, a series of computer-readable program code portions may be embodied in one or more computer program products and can be used, with a computing device, server, and/or other programmable apparatus, to produce the machine-implemented processes discussed herein.

Any such computer program instructions and/or other type of code may be loaded onto a computer, processor or other programmable apparatus's circuitry to produce a machine, such that the computer, processor other programmable circuitry that executes the code may be the means for implementing various functions, including those described herein.

It is also noted that all or some of the information presented by the example displays discussed herein can be based on data that is received, generated and/or maintained by one or more components of client device 105 and/or 110. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Embodiments of the present invention have been described above with reference to block diagrams and flowchart illustrations of methods, apparatuses, systems and computer program products. Each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus, such as processor 902 and/or payment/redemption module 910 discussed above with reference to FIG. 9, to produce a machine, such that the computer program product includes the instructions which execute on the computer or other programmable data processing apparatus create a means for implementing the functions specified in the flowchart block or blocks.

These computer program instructions may also be stored in a computer-readable storage medium (e.g., memory 904) that can direct a computer or other programmable data processing apparatus to function in a particular manner, such that the instructions stored in the computer-readable storage medium produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, the block diagrams and flowchart illustrations support combinations of means for performing the specified functions, combinations of steps for performing the specified functions and program instruction means for performing the specified functions. It will also be understood that each block/step of the circuit diagrams and process flowcharts, and combinations of blocks/steps in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. For example, although the examples discussed herein do not require the consumer to present a form of payment (such as a credit card) to the merchant, some embodiments of the merchant device can be configured to work with one or more peripheral devices that can receive payment information directly from a consumer (such as a credit card reader, radio frequency identification reader, etc.) in addition to or instead of from the central system. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1.-30. (canceled)

31. A method comprising:
receiving, via an ad-hoc network, at a second device, a notification indicating that a first device is within a predetermined proximity to the second device and is sharing a promotion over the ad-hoc network;
causing display, at the second device, of an indication indicating reception of the notification and requesting an input indicative of whether to connect to the first device;
subsequent to the connection to the first device, displaying a plurality of selectable indications comprising instructions to view, save, and accept the promotion;
receiving a selection of an acceptance of the promotion; and
causing display, at the second device, of the promotion.

32. The method of claim 31, further comprising:
receiving a request, from the first device, to identify devices able to receive wireless communication from the first device;
revealing itself, to the first device, in response to the request to identify devices able to receive wireless communication from the first device;
receiving an invitation to connect to the first device;
displaying, at the second device, an indication indicating reception of the invitation to connect to the first device;
receiving, at a user interface of the second device, via user input, a selection of an acceptance of the invitation; and
connecting to the first device.

33. The method of claim 31, further comprising:
displaying, at the user interface of the second device, the indication indicating reception of the notification and an option to purchase the promotion concurrently.

34. The method of claim 31, wherein the notification, received at the second device, indicating that the first device is sharing the promotion, comprises an indication that the first device is sharing the promotion via the ad hoc-network.

35. The method of claim 31, wherein the notification, received at the second device, indicating that the first device is sharing the promotion, comprises an indication that the first device is sharing the promotion via email.

36. The method of claim 31, wherein the notification, received at the second device, indicating that the first device is sharing the promotion, comprises an indication that the first device is sharing the promotion via a social media network.

37. The method of claim 34, further comprising: receiving, at the second device, the promotion, from the first device directly via the ad-hoc network.

38. A device comprising processing circuitry configured to:
receiving, via an ad-hoc network, at a second device, a notification indicating that a first device is within a predetermined proximity to the second device and is sharing a promotion over the ad-hoc network;
causing display, at the second device, of an indication indicating reception of the notification and requesting an input indicative of whether to connect to the first device;
subsequent to the connection to the first device, displaying a plurality of selectable indications comprising instructions to view, save, and accept the promotion;
receiving a selection of an acceptance of the promotion; and
causing display, at the second device, of the promotion.

39. The device of claim 38 further comprising processing circuitry configured to:
receiving a request, from the first device, to identify devices able to receive wireless communication from the first device;
revealing itself, to the first device, in response to the request to identify devices able to receive wireless communication from the first device;
receiving an invitation to connect to the first device;
displaying, at the second device, an indication indicating reception of the invitation to connect to the first device;
receiving, at a user interface of the second device, via user input, a selection of an acceptance of the invitation; and
connecting to the first device.

40. The device of claim 38 further comprising processing circuitry configured to:
displaying, at the user interface of the second device, the indication indicating reception of the notification and an option to purchase the promotion concurrently.

41. The device of claim 38, wherein the notification, received at the second device, indicating that the first device is sharing the promotion, comprises an indication that the first device is sharing the promotion via the ad hoc-network.

42. The device of claim 38, wherein the notification, received at the second device, indicating that the first device is sharing the promotion, comprises an indication that the first device is sharing the promotion via email.

43. The device of claim 38, wherein the notification, received at the second device, indicating that the first device is sharing the promotion, comprises an indication that the first device is sharing the promotion via a social media network.

44. The device of claim 41 further comprising processing circuitry configured to:
receiving, at the second device, the promotion, from the first device directly via the ad-hoc network.

45. A computer program product comprising at least one computer-readable storage medium having computer-executable program code instructions stored therein, the computer-executable program code instructions comprising program code instructions for:
receiving, via an ad-hoc network, at a second device, a notification indicating that a first device is within a predetermined proximity to the second device and is sharing a promotion over the ad-hoc network;
causing display, at the second device, of an indication indicating reception of the notification and requesting an input indicative of whether to connect to the first device;
subsequent to the connection to the first device, displaying a plurality of selectable indications comprising instructions to view, save, and accept the promotion;
receiving a selection of an acceptance of the promotion; and
causing display, at the second device, of the promotion.

46. The computer program product according to claim 45, wherein the computer-executable program code instructions further comprise program code instructions for:
receiving a request, from the first device, to identify devices able to receive wireless communication from the first device;
revealing itself, to the first device, in response to the request to identify devices able to receive wireless communication from the first device;
receiving an invitation to connect to the first device;
displaying, at the second device, an indication indicating reception of the invitation to connect to the first device;
receiving, at a user interface of the second device, via user input, a selection of an acceptance of the invitation; and
connecting to the first device.

47. The computer program product according to claim 45, wherein the computer-executable program code instructions further comprise program code instructions for:
displaying, at the user interface of the second device, the indication indicating reception of the notification and an option to purchase the promotion concurrently.

48. The method of claim 45, wherein the notification, received at the second device, indicating that the first device is sharing the promotion, comprises an indication that the first device is sharing the promotion via the ad hoc-network.

49. The method of claim 45, wherein the notification, received at the second device, indicating that the first device is sharing the promotion, comprises an indication that the first device is sharing the promotion via email.

50. The method of claim 45, wherein the notification, received at the second device, indicating that the first device is sharing the promotion, comprises an indication that the first device is sharing the promotion via a social media network.

51. The computer program product according to claim 48, wherein the computer-executable program code instructions further comprise program code instructions for: receiving, at the second device, the promotion, from the first device directly via the ad-hoc network.
